(19) United States
(12) Patent Application Publication
(10) Pub. No.: US 2005/0091963 A1
(43) Pub. Date: May 5, 2005

(54) Aircraft turbine engine and an air ejection assembly for use therewith

(76) Inventor: Gongling Li, Singapore (SG)

Correspondence Address: WILMER CUTLER PICKERING HALE AND DORR LLP, 60 STATE STREET, BOSTON, MA, 02109, US

(21) Appl. No.: 10/697,844

(22) Filed: Oct. 30, 2003

(51) Int. Cl. F02C 7/00

(52) U.S. Cl. 60/262; 60/39.5

(57) ABSTRACT

An air ejection assembly for unsteadying an exhaust plume discharged from an exhaust end of a turbine engine during operation. A turbine engine incorporating the air ejection assembly and a method of unsteadying an exhaust plume are also disclosed.

### FIELD OF THE INVENTION

The present invention relates to a turbine engine. More particularly, the present invention relates to an air ejection assembly and method for suppressing infrared radiation emitted by exhaust plume discharged from a turbine engine of a supersonic aircraft.

### BACKGROUND OF THE INVENTION

Most modem military aircrafts are powered by turbine engines. The turbine engine is essentially a heating engine burning air with fuel to provide thrust in the form of a high velocity jet. Some turbine engines have a reheat operation which combusts the exhaust and bypass fan air with additional fuel in an afterburner. The exhaust, being at a high temperature and pressure, discharges from the turbine engine's exhaust nozzle at a very high speed to produce high exit kinetic energy. However, this high temperature exhaust gas emits an infrared signature, which endangers the military aircraft as a target for infrared guided missiles.

Faster cooling of the exhaust plume reduces the infrared signature and has military importance. An effective way to reduce the temperature of the exhaust plume involves mixing the exhaust plume with bypass fan air or cool ambient air. Therefore, there are continual efforts by jet engine manufacturers and researchers to search for effective and efficient mixing enhancement solutions.

Another approach exemplified by U.S. Pat. No. 4,502,639 issued on 5 Mar. 1985 to Marietta, et al. and U.S. Pat. No. 6,179,225 issued on 30 Jan. 2001 to Bouiller, et al. discloses methods to suppress infrared radiation in a turbine engine by opening additional air inlets which admit or scoop in ambient air to cool the hot exhaust plume. The opening of these air inlets is controlled by movable flaps so that the device can cope with various operational conditions of combat manoeuvres. However, these devices for infrared suppression increase the complexity and weight of the turbine engine.

U.S. Pat. No. 6,314,721 issued on 13 Nov. 2001 to Mathews, et al. and U.S. Pat. No. 6,502,383B1 issued on 7 Jan. 2003 to Janardan, et al. disclose a vortex generator technique to enhance mixing of the exhaust and the ambient air. A vortex generator is typically mounted at the exit of a nozzle protruding into the flow path of exhaust gases. Vortex generators introduce large scale vortices behind them which can significantly enhance the mixing between the exhaust gases and bypass fan air or ambient air. However, vortex generators produce blockages to the flow path of exhaust gases, thereby reducing engine thrust.

U.S. Pat. No. 6,308,898 B1 issued on 30 Oct. 2001 to John, et al. discloses a technique of gas injection for mixing enhancement in a subsonic engine. Periodic pulsed jets of fluid are injected from two or more locations spaced circumferentially about the exhaust plume to push the exhaust plume into an unsteady state. The jets are pulsed out of phase relative to one another and are controlled by a pulse generator. However, this technique injects gas inside the exhaust nozzle and cannot be applied to a turbine engine having an adjustable nozzle. Gas injection inside the nozzle reduces the effective cross-sectional area of the nozzle, which is critical to the performance of a supersonic turbine engine. Further, pulsed gas injection requires a considerable amount of gas due to the significant energy lost in the pulse generator.

There is accordingly a need to suppress the infrared signature of aircraft by enhancing the mixing between the hot plume and ambient cool air without the significant disadvantages in the known techniques of doing so. It is an objective of the invention to address this need, if not completely, at least substantially. It is a further objective of this invention to provide an alternative air ejection assembly and method for unsteadying an exhaust plume discharged from a turbine engine.

### SUMMARY

According to one aspect of the present invention, there is an air ejection assembly for unsteadying an exhaust plume discharged from an exhaust end of a turbine engine during operation, the air ejection assembly comprising an input port configured to receive air from the turbine engine; and an output port in fluid communication with the input port; wherein the output port is located adjacent to and outside of the exhaust end and configured to emit air to pierce a core of the exhaust plume

According to a further aspect of the present invention, there is provided a turbine engine comprising a compressor for compressing air drawn into the engine; a combustor to combust a mixture of the air compressed by the compressor and fuel drawn into the combustor; a turbine driven by the combusted air/fuel mixture; an exhaust end for guiding an exhaust plume out of the turbine engine; and an air ejection assembly as according to the preceding aspect of the present invention.

According to a further alternative aspect of the present invention, there is provided a method of unsteadying an exhaust plume discharged from a turbine engine comprising the steps of receiving air from of the turbine engine; and directing the air from a location adjacent to and outside of the exhaust end of the engine to pierce a core of the exhaust plume.

### BRIEF DESCRIPTION OF DRAWINGS

Further features of the present invention will be readily apparent from the following detailed description of a non-limiting example, with reference to the accompanying drawings, in which:

FIG. 1 is a schematic cross-sectional view of a supersonic turbine engine of a military aircraft;

FIG. 1a is a partial view of the turbine engine of FIG. 1 having a fluid control valve with an alternative arrangement.

FIG. 2 is an explanatory view showing states of air mixing at an exhaust end of the turbine engine of FIG. 1;

FIG. 3a is a Schlieren photograph taken at an exhaust end of an exhaust nozzle without air sprays;

FIG. 3b is a Schlieren photograph taken at an exhaust end of an exhaust nozzle with air sprays;

FIG. 4 is a military aircraft having an air ejection assembly with an alternative mounting arrangement;

FIG. 5 is a military aircraft having an air ejection assembly with a further alternative mounting arrangement; and

FIG. 6 is a graph illustrating a velocity distribution of exhaust plumes with and without air ejection.

Where the same reference numeral appears in more than one of the accompanying drawings, it is used to denote the same element.

### DETAILED DESCRIPTIONS

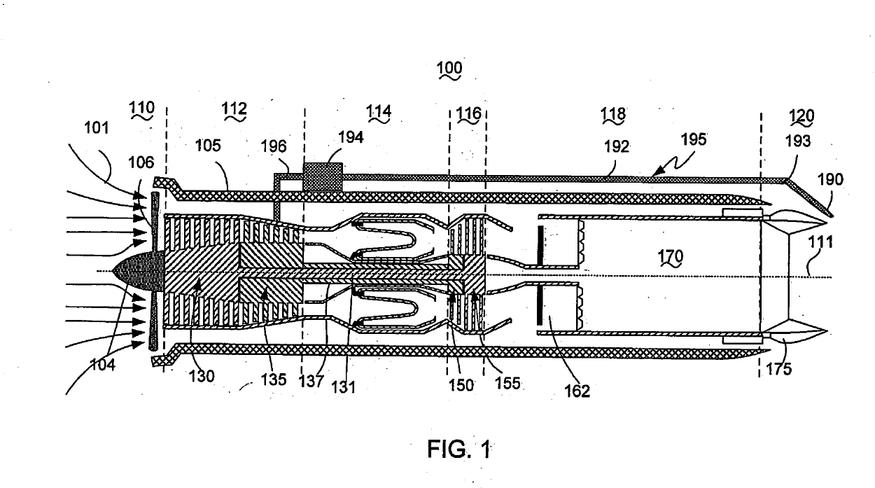

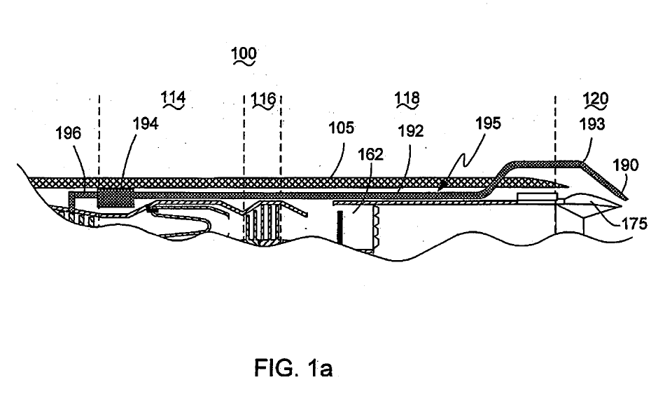

FIG. 1 illustrates a schematic cross-sectional view of a turbine engine 100 incorporating an air ejection assembly 195. The air ejection assembly may also be used on other engines of similar configuration and the reference to the turbine engine 100 is for illustrative purposes only. The turbine engine 100 has several sections housed within a nacelle 105, with each section performing different functions. An air intake section 110 is followed by an air compression section 112, a combustion section 114, a turbine section 116, an afterburner section 118 and an exhaust end section 120.

The air intake section 110 includes a fan 104 having a plurality of fan blades 106 mounted on the fan 104. The fan 104 will draw air 101 into the nacelle 105 while rotating. The compression section 112 compresses the intake air 101 in two stages. A preliminary compression is performed by a low pressure compressor 130 which rotates about a longitudinal axis 111 during operation. A first shaft 131 is connected to the body of the low pressure compressor 130 on one end for driving the low pressure compressor 130 The compression section 112 further includes a high pressure compressor 135 to further compress the air 101. The high pressure compressor 135 is driven by a second shaft 137, which rotates about the longitudinal axis 111 during operation.

The combustion section 114 is a first burning area of the turbine engine 100. It is configured to burn large quantities of fuel with the compressed air 101 to provide power. The turbine section 116 may include two separate turbines. A high pressure turbine 150 precedes a low pressure turbine 155. The low pressure turbine 155 drives the low pressure compressor 130 via the first shaft 131. The high pressure turbine 150 drives the high pressure compressor 135 via the second shaft 137. The first shaft 131 and the second shaft 137 are disposed concentrically along the same axis with the second shaft 137 encapsulating the first shaft 131.

The afterburning section 118 is a second burning area of the turbine engine 100 for burning raw fuel with unburnt oxygen in the exhaust gas discharged from the turbine section 116 and bypass fan air to provide additional engine thrust. Due to its large fuel consumption, afterburning is used only occasionally when maximum thrust is required. The afterburned exhaust is guided through an afterburning duct 170 and shot out from an adjustable nozzle 175 of the exhaust end section 120. The adjustable exhaust nozzle 175 may include a group of adjustable blades to change the diameter of the exhaust nozzle 175.

An air injection assembly 195 is mounted along the nacelle 105 encasing the turbine engine 100 and includes a first pipe 196 having an inlet extending through the nacelle 105 into the compression section 112 to tap compressed air from within the compression section 112. The outlet end of the first pipe 196 is connected to the inlet of a fluid control valve 194. The fluid control valve 194 outlet is connected to the inlet of a second pipe 192 which has an air ejection nozzle 190 at its outlet end. The fluid control valve 194 may be pneumatic or electric in nature and could either function as an on/off valve or modulation valve for controlling air ejection. The second pipe 192 includes an angled portion 193 near the ejection nozzle 190 which is angled towards the longitudinal axis 111 of the adjustable exhaust nozzle 175. The ejection nozzle 190 is located adjacent the trailing edge of the adjustable exhaust nozzle, outside of the exhaust nozzle. The ejection nozzle may also be located outside of the exhaust plume.

It is understood that the air ejection assembly 195 is not limited to the above embodiment. FIG. 1a illustrates a partial view of an air ejection assembly 195 where the fluid control valve 194 and the first pipe 196 and second pipe 192 are completely or partially encased within the nacelle 105 encasing the turbine engine 100, with only the angled portion 193 or apart thereof exposed beyond the trailing edge of the nacelle 105.

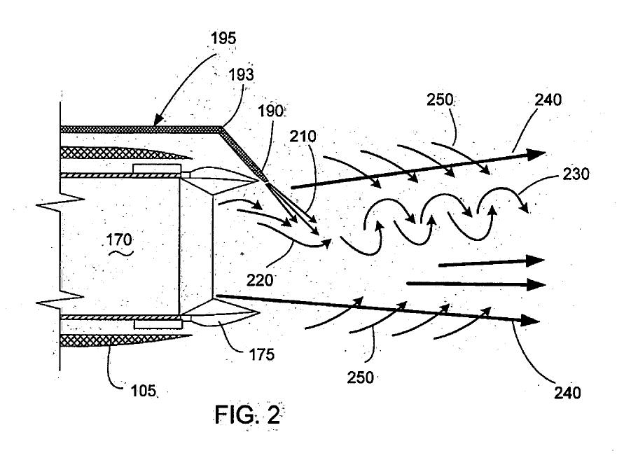

FIG. 2 illustrates the fluid flow and mixing that may occur at the exhaust end section 120 while the air ejection assembly 195 is in spray state. During the spray operation, a small amount of compressed air 101 is tapped from the compression section 114, flows through the control valve 194 via the first pipe 196, and ejects through the ejection nozzle 190 via the second pipe 192. The compressed air may be tapped from the high pressure compressor 135 and the amount of air tapped may be less than 4% of the air compressed in the high pressure compressor 135. Further, the angled portion 193 may be configured to spray air at a converging angle of 30° to 90° towards the longitudinal axis of the exhaust nozzle 175. Tests have indicated that although a specific air ejection assembly 195 as described ejects compressed air 210 at a flow rate of less than 2% of the air flow rate in the high pressure compressor 135, the ejected air 210 has a much higher pressure and speed than the gases 220 of the exhaust plume 240 and was sufficient to significantly unsteady the gases 220 of the exhaust plume 240.

The ejected air 210 pierces into the core of the exhaust plume 240 and breaks up a shear boundary of the exhaust plume 240 thereby helping to engulf ambient air 250 and mix the ambient air into the core of the exhaust plume 240. This introduces large scale vortices 230 in the exhaust plume 240. No loss to the engine thrust results as the vortices 230 are introduced outside of the exhaust end 120. The vortex generation encourages the plume into unsteady mode thereby suppressing infrared emission. A further surprising advantage of additional thrust is also provided.

The air ejection nozzle 190 may be a convergent nozzle or a convergent-divergent nozzle to provide higher spray speed of the ejected air 210 than that of the discharge speed of the exhaust plume 240. Further, the control valve 194 of the air ejection system 195 may be configured to provide a continuous spray with minimum pressure loss of the ejected air 210.

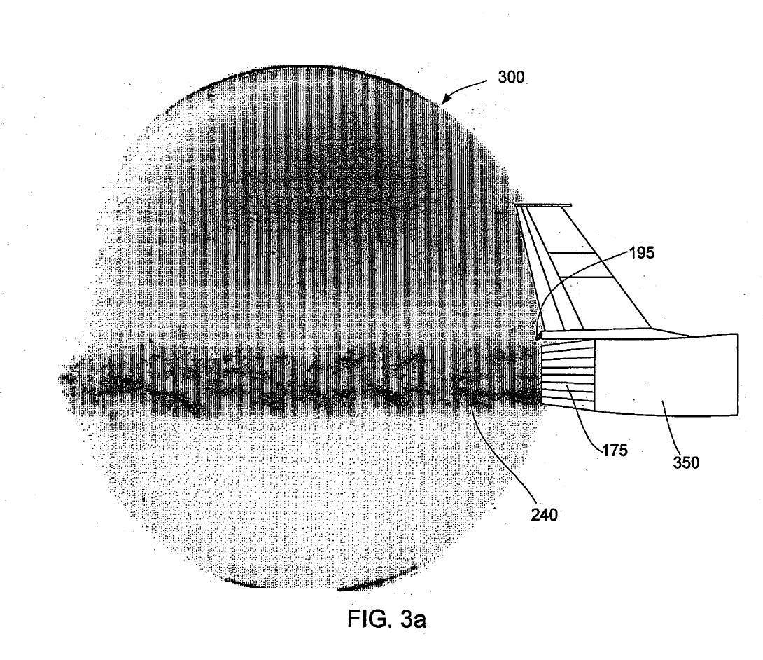

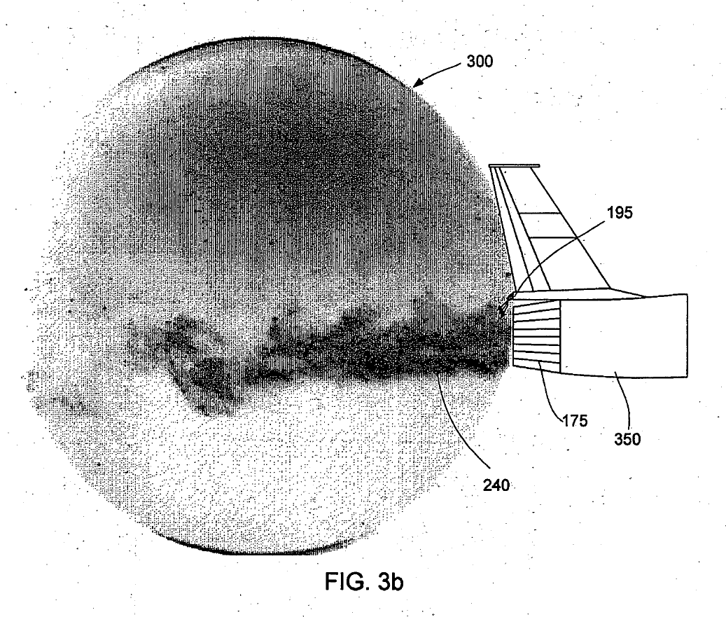

FIG. 3a is a Schlieren photograph 300 taken at the end of an exhaust nozzle 175 at Mach 1.5 while the air ejection system 195 is not in operation and shows an exhaust plume 240 having a length 16 times the diameter of the exhaust nozzle 175. FIG. 3b shows another Schlieren photograph 300 taken for the exhaust nozzle at Mach 1.5 with the air ejection system 195 in operation and ejecting air at a converging angle of 45° to the longitudinal axis of the exhaust plume 240. The latter photograph 300 shows that the length of the exhaust plume 240 has shortened to 10 times the diameter of the exhaust nozzle 175.

To avoid complicated mechanical reworking of aircraft bodies, the air ejection assembly 195 may be installed external to the nacelle 105 encasing the turbine engine. However, it is envisaged that the air ejection assembly 195 may be installed within the aircraft body, for example, within the fuselage 355 of the aircraft 350 or within the nacelle 105 encasing the turbine engine, to minimize aerodynamic interference.

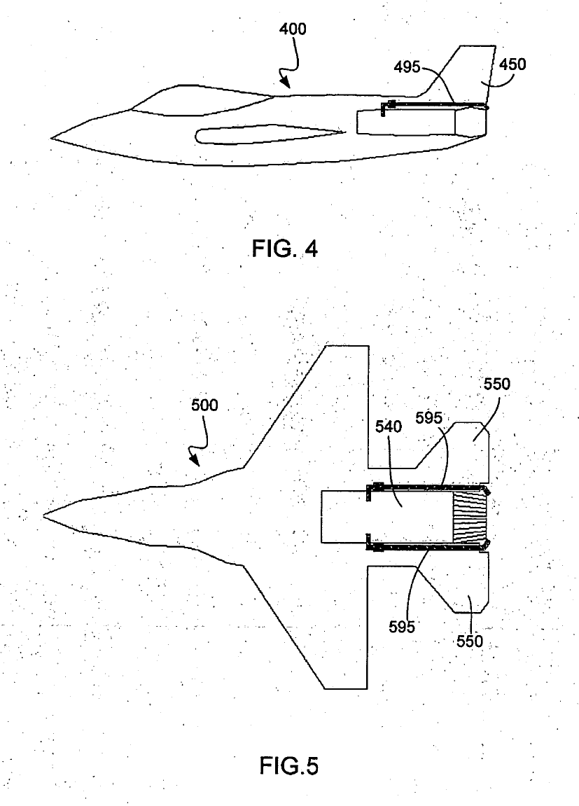

FIG. 4 show an alternative embodiment of an air ejection assembly 195 of the present invention hidden under a vertical tail 450 of an aircraft 400. FIG. 5 shows a further alternative of mounting a pair of air ejection assemblies 359 along opposite aspects of a turbine engine 540 of an aircraft 500 and each hidden inside a corresponding horizontal tail 550.

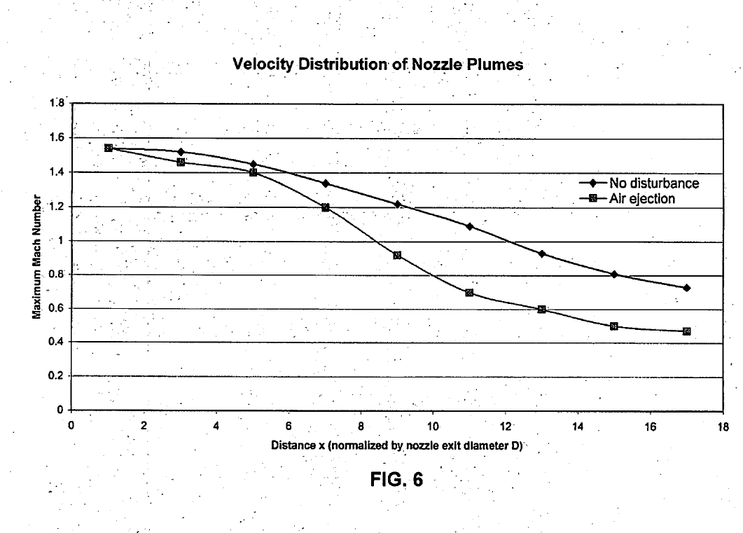

FIG. 6 shows a graph indicating the maximum velocity (Mach number) of the exhaust plume 240 at an axial distance x from the exhaust nozzle 175. The distance was normalized by the diameter, D, of the exhaust nozzle 175. The diamond symbols represent the results taken without air disturbance (i.e. no air ejection) whilst the square symbols represent the results taken with air ejection. The results show that, for example, the exhaust plume 240 took a distance of 12.2D to slow down to 1.0 Mach when there is no air ejection with a distance of only 8.3D with air ejection. The more rapid reduction in velocity of the exhaust plume indicates that larger amount of ambient air has been engulfed into the exhaust plume 240, thereby cool down the exhaust plume 240 faster, hence suppressing IR signature.

It is understood by those skilled in the art that even though numerous characteristics and advantages of various preferred embodiments of the present invention have been set forth in the foregoing description, this disclosure is illustrative only. Other modifications may be made, especially in matters of structure, arrangement of parts and/or steps within the principles of the invention to the full extent indicated by the broad general meaning of the appended claims without departing from the scope of the invention.

1. An air ejection assembly for unsteadying an exhaust plum discharged from an exhaust end of a turbine engine during operation, the air ejection assembly comprising:
an input port configured to receive air from the turbine engine; and
an output port in fluid communication with the input port;
wherein the output port is located adjacent to and outside of the exhaust end and configured to emit air to pierce a core of the exhaust plume.

2. The air ejection assembly according to claim 1, further comprising a fluid control valve in fluid communication between the input port and the output port for regulating the air emitted by the output port.

3. The air ejection assembly according to claim 1, wherein the input port is configured to receive compressed-air from the turbine engine.

4. The air ejection assembly according to claim 3, wherein the input port is further configured to receive up to 4% of the compressed air within the turbine engine.

5. The air ejection assembly according to claim 1, wherein the output port is located outside of the exhaust plume.

6. The air ejection assembly according to claim 1, wherein the output port is configured to emit air in a continuous manner.

7. The air ejection assembly according to claim 1, wherein the output port is configured to emit air at a converging angle of 30° to 90° relative to the longitudinal axis of the exhaust plume.

8. The air ejection assembly according to claim 1, wherein the output port is a convergent nozzle.

9. The air ejection assembly according to claim 1, wherein the output port is a convergent-divergent nozzle.

10. The air ejection assembly according to claim 2, wherein the fluid control valve is a pneumatic on/off valve or an electric on/off valve.

11. The air ejection assembly according to claim 2, wherein the fluid control valve is a pneumatic modulation valve or an electric modulation valve.

12. A turbine engine comprising:
a compressor for compressing air drawing into the engine;
a combustor to combust a mixture of the air compressed by the compressor and fuel drawn into the combustor;
a turbine driven by the combusted air/fuel mixture; and
an exhaust end for guiding an exhaust plume out of the turbine engine;
an air-ejection assembly as according to ay one of the preceding claims.

13. The turbine engine according to claim 12, further comprising an afterburner disposed behind the turbine.

14. The turbine engine according to claim 12, wherein the exhaust end is an adjustable nozzle.

15. The turbine engine according to claim 12, wherein the input port of the air ejection assembly is configured for receiving air from the compressor.

16. A method of unsteadying an exhaust plume discharge from a turbine engine comprising the steps of:
receiving air from of the turbine engine; and
directing the air from a location adjacent to and outside of the exhaust end of the engine to pierce a core of the exhaust plume.

17. The method according to claim 16, wherein the air is ejected in a continuous manner.

18. The method according to claim 16, wherein the air received is compressed.

19-21. (canceled)
